(19) United States
(12) Patent Application Publication
(10) Pub. No.: US 2015/0227945 A1
(43) Pub. Date: Aug. 13, 2015

(54) IMMUNOPROFILE CREDENTIALING SYSTEM

(71) Applicant: ImmunoProfile, LLC, East Brunswick, NJ (US)

(72) Inventor: William Francis Shea, III, West Hartford, CT (US)

(21) Appl. No.: 14/619,435

(22) Filed: Feb. 11, 2015

Related U.S. Application Data
(60) Provisional application No. 61/938,482, filed on Feb. 11, 2014.

(51) Int. Cl. G06Q 30/00; G06F 19/00; G06Q 50/22

(52) U.S. Cl. CPC G06Q 30/018; G06Q 50/22; G06F 19/322

(57) ABSTRACT

A system to store, manage and maintain individual's immunity status (immunoprofile) reports in a secure database to be used to grant access to designated locations. The results of the immunity status diagnostic tests are verified and credentials are issued certifying the individual's immunoprofile is current per national guidelines. These credentials establish the individual is not a health risk to others. The immunoprofile credentials are managed and maintained for example on an annual basis and can be accessed by administrators in order to permit visitors access to their facilities.

### CROSS-REFERENCE TO RELATED APPLICATION

This application is claims benefit of U.S. Provisional Patent Application Ser. No. 61/938,482, filed Feb. 11, 2014, which is incorporated herein by reference in its entirety.

The present invention relates to, among other things, a system to store, manage and maintain individual's immunity status (immunoprofile) reports in a secure database to be used to grant a cleared individual access to designated locations. The system leverages a point of care diagnostic instrument or other reliable source of information in order to ascertain the individual's immunity status. The results of the diagnostic tests are then verified and credentials are issued certifying the individual's immunoprofile is current per national guidelines or other criteria as determined from time to time. These credentials establish the individual is not a health risk to others or that others are not a risk to the individual per their immunity status. The immunoprofile credentials are managed and maintained on an established basis (such as an annual basis or other time intervals) and can be accessed by administrators in order to permit visitor access to their facilities knowing they do not pose a health risk to others or themselves.

In the prior art various types of immune status systems have been proposed. For example, U.S. Pat. No. 8,498,879 to Michon et al discloses an immunological based system to find trends and patterns relating to immune status of individuals and using such information to aid in healthcare decision making.

The current system relates to providing information regarding the immune status of individuals relative to possibly contracting a multitude of possible diseases. The diseases to be assessed will change over time and could be any disease for which there is presently, may have in the future, or may never have a vaccine that offers protection.

The goal is to provide a method to track individual's immune status relative to vaccination status relative to all diseases or as many as practical, especially those for which vaccination is available. It is important to know which individuals are protected against which possible diseases. Equally, if not more important, is to find the individuals that are not immunized or protected against various diseases. These individuals may pose to health risk to others especially when other members of the population are immune compromised or have contracted other forms of disease or illness. Individuals who do not meet the established standards will be noted in the database. They will have the option of addressing the identified gaps in their immunoprofile and get re-tested to establish having met the standards.

Point of care devices are being developed to test individuals to learn their vaccination status and to provide this information accurately in a short period of time. These devices will be valuable and likely used at a variety of points of usage. However, there is no way to communicate this information from one test site to another or to keep accurate records of the test results that could impact the population with whom these individuals come in contact. Thus, developing a database that stores this information about an individual's immune status or vaccination status, and whether or not vaccinations are up to date and providing the desired levels of protection will be very useful to society as a whole and to various subsets of society such as medical institutions or other sites where this information is particularly important. Some of the initial areas where the information will be useful include: hospitals and healthcare provider sites, places of large public gatherings (airports, train stations, bus stations, stadiums, etc.), transportation vehicles (airplanes, trains, buses, boats, etc.), places of known disease outbreaks, places of natural disasters (earthquakes, tidal waves, hurricanes, typhoons, tornados, etc.) and places where individuals may be immune comprised or where being immune compromised could have serious repercussions.

In all of the above and other applications, a central database that holds the status of a person's immune vaccinations can be utilized. It will tell a person's current status based upon when vaccines were given but even more importantly, when tests were given (based on testing devices or other reliable methods) and the results of those tests. The results will show the current status especially for particularly important disease states. The documentation will provide information as to when the person was tested last for a disease protection status and the results. The immunoprofile test should help insure that the person has the appropriate levels of protection against whatever diseases are of concern in a particular area or situation. Currently such a database does not exist and immune health records are in disparate locations and are not maintained or managed in a manner that can be securely accessed either by the individual or a third party with a legitimate need to know such information.

Beyond knowing the vaccination records it is more important to ascertain a person's immunity status or immunoprofile. It is common for an individual to have been administered the requisite vaccinations per an approved regimen and yet have gaps in their validated immunity status. The gaps can be a result of age, life changing event, acquiring an immunity impacting disease or being administered an old or expired vaccine among many other causes. The individual may be able to provide documentation that all vaccinations have been administered yet still have gaps in their immunity status. In fact, the individual may not even know that they have gaps in their immunity status and believe that they are protected when they are not protected. Thus it can be more important to know a person's current tested immunoprofile than the vaccination history and to confirm the individual is currently protected against known diseases and does not pose a threat to others or themselves. This is especially true for those who may be immune compromised or about to come in contact with someone who may be immune compromised.

In most cases individuals have neither kept current records of vaccinations nor have they maintained the schedule for vaccination boosters. This is one of the primary causes for individuals to have gaps in their immunoprofile. The use of a point care immunoprofile diagnostic test can ascertain the immunity status of individuals including identifying gaps. The gaps can then be addressed by the administration of the requisite vaccinations per consultation with a clinician. Optionally, a retest can then confirm that the immunoprofile is in the acceptable range.

Having an immunoprofile database that is current and easily accessible is particularly important in the medical field. Any person delivering, receiving, observing, or otherwise present (administrative or institution employees, those making deliveries, visitors, or anyone else present) during the delivery of healthcare needs to insure they are appropriately protected both for their benefit and the benefit of others. The medical staff, or anyone present, needs to insure protection from diseases that could be transferred from the patient to the providers or others present. Conversely, the patient needs assurances that the people with whom they come in contact are protected and not carrying a disease that could affect the patient in their potentially compromised state of health. So the patient needs protection from those providing care or otherwise present and those providing care and otherwise present need protection from the patient. And additionally, those providing healthcare (or otherwise present), need to know that their co-workers are protected from each other. These people work together daily and need to know that they are not being exposed to diseases through the working environment which is often involves working in close proximity in tight quarters.

Beyond the medical profession, having confidence in the immune status of co-workers would apply to numerous situations especially including any time people work together in close proximity. This could be in an office setting, other work environments, manufacturing plant, research lab, retail site, airplane, train, ocean vessel, entertainment site, restaurant, food service, those making sales calls or otherwise coming in contact with multiple people, or the like. It may especially applicable to the military where military personnel are in battle, on ships, planes, trains, etc. Basically, any time a group of people are together on a regular basis, or anytime a person (selling or otherwise) is traveling and contacting different groups of people.

It is envisioned that a responsible party would require that their employees or representatives maintain a current immunity status and maintain a record of such status. For example, medical companies would maintain a database, or instruct their employees to participate in a third party database, such that each of their employee's immune status would be known and that such information would be available to those who would need to know and be authorized to access this data. The same could apply to organizations in any field such as the military, food services, airplane transportation, train transportation, ocean transportation, entertainment, or other industries. The objective is to maintain an accurate record of selected individual's immune status and make that information available from a central location.

This invention is, in general, to establish a central database of individual's immunoprofile records that can be accessed by authorized administrations in order to grant access to cleared individuals to designated locations to help prevent the spread of disease. Individuals include human beings and all animals including but not limited to pets, farm animals and medical test animals. Individuals are sometimes referred to as person(s). When the word person(s) is used, it should be understood that the word “subject(s)” or “user(s)” can be substituted, with subject(s) or user(s) including both humans and animals. In other words, the invention is applicable to situations where the immune status of animals should be credentialed.

### SUMMARY OF THE INVENTION

The present invention is a database of individual's immunoprofile records that is maintained, managed and accessible by authorized users to determine whether an individual should be granted access to a designated location in order to help prevent the spread of disease. The database can be used in a number of locations including: hospitals and healthcare provider sites, places of large public gatherings (airports, train stations, bus stations, stadiums, etc.), transportation vehicles (airplanes, trains, buses, boats, etc.), places of known disease outbreaks, places of natural disasters (earthquakes, tidal waves, hurricanes, typhoons, tornados, etc.) and places where individuals may be immune comprised.

In one embodiment, the first step in the process is the individual verifying medical records and/or getting a diagnostic test to ascertain immunity status or immunoprofile. Once the results have been acquired, the results then need to be verified that a person's immunoprofile is complete without any gaps in protection. If it is determined that the antibody levels are insufficient in one or more areas then the individual will need to get vaccinated or have additional vaccinations in order to address the identified protection gaps. The next step, optionally, is to verify the immunoprofile test results. Once it is established through the immunoprofile test results that the individual does not have any gaps based upon prescribed antibody levels, the individuals results will then be considered verified.

In the following step the individual's immunoprofile results will then be uploaded into the database using the database software tools. At this point the system will issue the immunoprofile credentials. Depending upon the situation these credentials may have varying levels of detail with access to different detail levels available to selected user groups. It certifies the individual in question has an established immunity protection status. These credentials can become property of the individual. The credentials enable the individual to gain access to designated locations because they are deemed not to be a health risk to others or themselves.

The individual immunoprofile credentials are then stored, maintained and managed in the secure credentials database. The database is routinely updated to ensure records are current and secure to prevent unwarranted access.

The data (immunoprofile credential records and potentially other historical information) can be accessed via a data access port. Different types of users can access the data. Authorized administrators such as hospital officials or others with a need to know, can access the database via a secure link using a personalized login and password to view records of all approved or authorized individuals in the database, to whose immunoprofile information the administrator is authorized access. They can use the immunoprofile credential records to determine whether any particular individual can have access to their site because they are deemed not to be a health risk to others or themselves. On the other hand, individuals can also access the database via a secure link using a personalized login and password to view their own records. They cannot access the records of other individuals nor can they access the records of administrators. Nor can they change the immunoprofile data of their own records. In embodiments, only authorized test sites can update such records. For example, if a uses inputs additional vaccination records, such data is not incorporated into the immunoprofile unless reviewed and approved.

Animals are an additional group of individuals that can benefit from ascertaining their immunoprofile. In many ways they may be a greater beneficiary since they are unable to communicate their medical status. Similar to humans, when animals are together in groups it is important to know their individual immunoprofiles so they are not a danger to themselves or others. A corresponding database for animals will be established to cover a range of animal types including: pets, farm animals and medical test animals among others.

The system will work similarly with the exception that the animal's respective owner will be responsible for the animal's immunoprofile including the administration of the required vaccinations and have the individual animals tested to ascertain their lab-tested immunoprofile. If gaps are identified it will be the responsibility of the owner to address them. Similar to humans the results will be entered by authorized personnel and the records will only be available for viewing by authorized personnel.

Some examples when the animal immunoprofile system can be beneficial include pet travel, animal sales/auction and animal slaughter. These are just a few of the examples and thereby not limiting in scope but simply to offer clarification. In the case of pet travel it would be important to know the animal's immunoprofile so it would not pose a danger to the other animals also in transport and the animals in the new location. Conversely, it is important to know the animal's immunoprofile so the other animals it may be in potential contact also does not pose a danger. For instance, if the animal was traveling to a location where known disease outbreaks may occur, it would better to have the animal vaccinated in advance and the results confirmed with immunoprofile. Upon arriving at the new location the administering agent can login to the system and check the immunoprofile of the animal to ensure it is not in danger and also not a danger to others it may come into contact.

Similarly the credentialing system will be of benefit when animals are sold or slaughtered. The receiving party will want to know the immunoprofile of the animals in question to help ensure it has a clean bill of health. It is the animal's owner responsibility to maintain the immunological health of the animal and using the credentialing system provide a current immunoprofile as part of the animal's overall heath record. In this situation the animals can be tested at authorized locations and the immunoprofiles uploaded into the system by authorized personnel. At the time of transfer (sale or slaughter) the receiving party who is an authorized system user can ascertain the immunoprofiles of the animals in question by viewing the immunoprofile records of the animals. If the immunoprofile record is not found or presents gaps then that information can impact the elements of the transaction among the parties in question. The immunoprofile credentialing system simply makes the records available and easily and securely accessible by authorized users. Similar to application in humans it does not make recommendations or suggest actions. Those decisions are left to the individual parties.

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only illustrative embodiments of this invention and are therefore not to be considered limiting of its scope or inclusive of every embodiment, for the invention may admit to other equally effective embodiments.

These and other features and advantages of embodiments of the present invention will be fully apparent from the following description, when taken in connection with the included drawings.

### BRIEF DESCRIPTION OF THE DRAWINGS

FIG. 1 is a detailed view of immunoprofile credentialing system.

FIG. 2 is a schematic of a Verification Center, and persons or institutions with which, in embodiments, the Verification Center interacts.

To facilitate understanding, reference numerals have been used, where possible, to designate comparable elements that are common to the figures. The figures are not drawn to scale and may be simplified for clarity. It is contemplated that elements and features of one embodiment may be beneficially incorporated in other embodiments without further recitation.

### DETAILED DESCRIPTION OF THE INVENTION

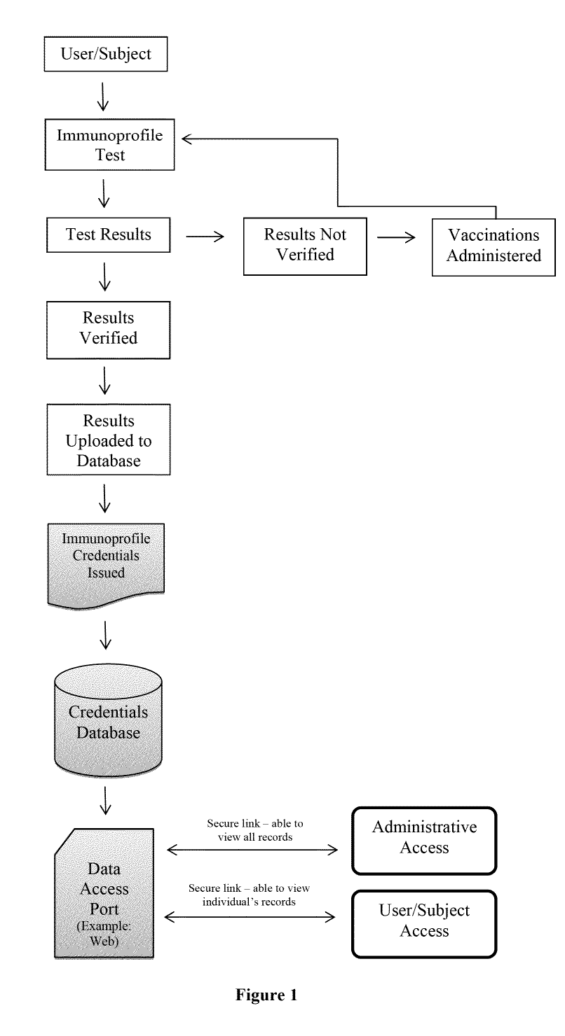

Referring now to the drawings in greater detail, FIG. 1 shows a detailed view of an exemplary immunoprofile credentialing system. The present invention is a database of individual's immunoprofile records that is maintained, managed and accessible by authorized users to determine whether an individual can be safely cleared to be granted access to a designated location to help prevent the spread of disease. The database can be used in a number of locations including: hospitals and healthcare provider sites, places of large public gatherings (airports, train stations, bus stations, stadiums, etc.), transportation vehicles (airplanes, trains, buses, boats, etc.), places of known disease outbreaks, places of natural disasters (earthquakes, tidal waves, hurricanes, typhoons, tornados, etc.) and places where individuals may be immune comprised.

The first step in the process is the individual getting a diagnostic test to ascertain one's immunity status or lab-tested immunoprofile. This can be done in a number of ways including a point of care immunization test. This tests the individual's antibody levels using the individual's fluid sample to determine a person's immunization protection levels across a range of identified diseases per the national medical guidelines of said individual. Once the results have been acquired, the results then need to be verified that a person's immunoprofile is complete without any gaps in protection. In one embodiment, the verification center runs a software analysis comparing the criteria established for a given facility against the immunoprofile data to determine gaps. If it is determined that the antibody levels are insufficient in one or more areas then the individual will need to get vaccinated in order to address the identified protection gaps. After administering the vaccines the individual will need to wait for a period of time (such as determined by the clinician) in order for antibody levels to achieve the requisite levels. Once the time period has been elapsed the individual will again be tested to determine the individual's antibody level to ascertain his/her immunoprofile.

The next optional step is to verify the immunoprofile test results. Once it is established through the immunoprofile test results that the individual does not have any gaps in their immunoprofile based upon prescribed antibody levels, the individuals results will then be considered verified. Only authorized personnel or a software-driven comparison by the verification center will be allowed to verify results.

In the following step the individual's immunoprofile results will then be uploaded or updated into the database using the database software tools. Only authorized individuals with appropriate security clearances will be allowed to input the verified test results into the database. If the individual is new to the system a new account will need to be established. If the individual has an existing account the results can be simply updated. During this process, the user will establish a secure and personal login and password to protect individual privacy. This login and password will remain with the individual and it is the individual's responsibility to protect the login identification and password in a manner similar to how one protects one's ATM (automatic teller machine) login and password information.

At this point the system will issue the immunoprofile credentials. The system certifies the individual in question has an established immunity protection status per determination of antibody levels. These credentials can be the property of the owner of the database but the tested individual will generally pay a fee for the diagnostic test and the establishment and maintenance of their credentials in the database. The credentials assist the individual to gain access to participating locations because they are deemed not to be a health risk to others or themselves.

The individual immunoprofile credentials are then stored, maintained and managed in the secure credentials database. The database is routinely updated to ensure records are current and secure to prevent unwarranted access.

The data (immunoprofile credential records) can be accessed via a data access port. An example of the data access port can be a secure website portal or other forms of access all of which could use proprietary software. The data access port can be available at all times 24 hours/7 days a week per user needs.

Different types of users can access the data. Authorized administrators such as hospital officials can access the database via a secure link using a personalized login and password to view records of all individuals in the database for whom they are authorized access. They can use the immunoprofile credential records to determine whether any particular individual can have access to their site because they are deemed not to be a health risk. On the other hand, individuals whose information is contained in the database can also access the database via a secure link using a personalized login and password to view their own records. Individuals can monitor their personal profile to ensure payments; employment records and contact information are current and advise the database manager if there are any perceived inaccuracies. In embodiments, Immunoprofile data can only be updated through testing and/or updating results and credential review.

The model is to have multiple sites where a simple test can be performed on certified equipment. The result of that test can be entered by authorized individuals into a large database that is maintained in a central location. Timing notifications can be provided to each individual that their test needs to be updated and such information can be added to their profile file by authorized individuals following the performance of the test. Then, with authorization, any interested party can access the database and determine if the person who will be in their presence is appropriately protected. Such access is provided with appropriate consent.

The business model may also work from the other side as well. In other words, the company being visited by sales reps, suppliers, financial auditors, maintenance personnel, consultants, etc., may want to know the status of those present in their facilities (which can include a particular area of a larger facility, such as a critical care facility in a hospital).

As an example, medical sales reps often view surgical procedures in which their company's products are used. The hospital needs to know that this sales rep is up to date on their vaccinations. But, they never know the status of his/her protection. They only know they have been vaccinated or have papers to show they have been vaccinated. Even this paperwork is not standardized and the procedures at each hospital vary widely. Also, the sophistication with which companies maintain their sales reps information is questionable. Thus, this approach is to standardize these procedures and make the information available to all interested parties thorough a central repository protected by password and other need to know access protections that comply with all laws and regulations.

The invention includes methods comprising the functionality described for any embodiment of the database system or of the periphery devices operative with the system.

### Verification Center

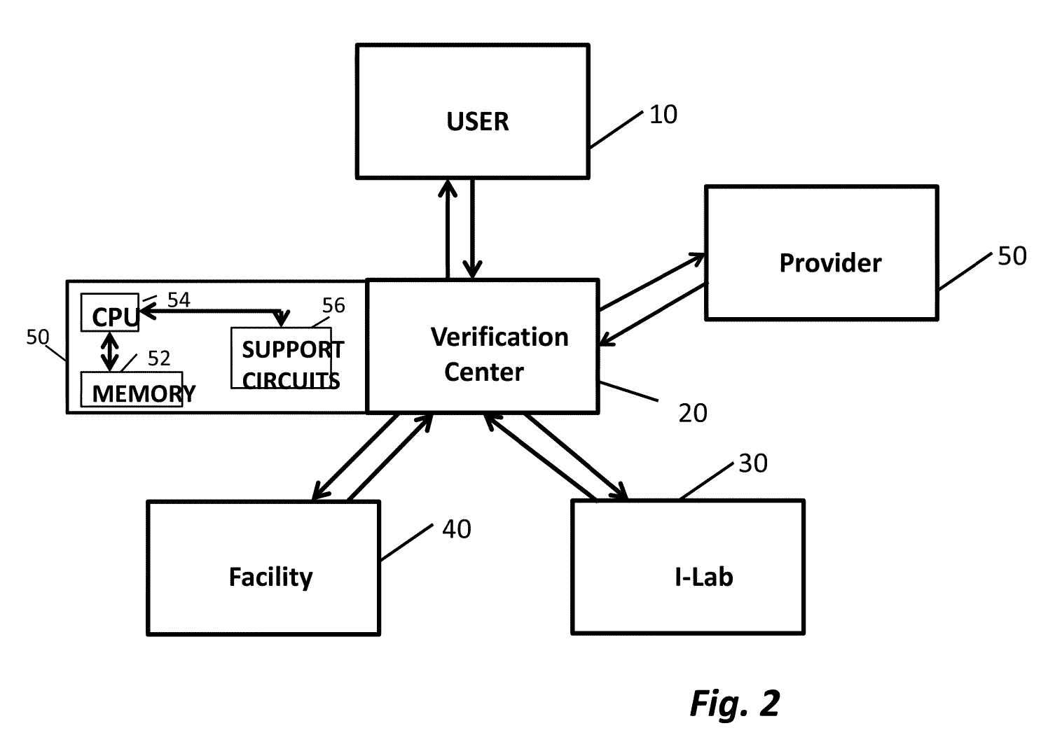

In one aspect of the invention, the user or his designee 10 interacts electronically via a portal with a Verification Center 20 (FIG. 2). The user 10 establishes or updates an account by, among other things, providing background information to the Verification Center 20, such as age, address, employer and other information, or such as immunization history, or such as Facilities 40 to which the User would like access. The immunization history information can include input on whether a given immunization can be validated with a certification (such as a letter from the provider of the immunization), and copies of such certifications.

The Verification Center 20 can output to the User 10 a credential that the User 10 can use to access its account with the Verification Center 20. The user credential can initially be temporary, with the User 10 accessing to Verification Center 20 to establish a more permanent credential. The credential can be a written or spoken password, a biometric parameter, or the like.

In embodiments, the Verification Center 20 can evaluate the User account to provide a report to the User 10 on Facilities 40 that will accept User's immunization history, and which will require more immune status validation to allow User to enter sensitive areas of the Facility 40. Such a report can be tailored in response to the User's inputed preferences (e.g., facilities in New England, or in the greater Boston region or as part of a specific hospital or business facility). In embodiments, the User 10 inputs the panel of pathogens for which it needs verification of immune status. The credentialing system will be able to accommodate individual Facility 40 requirements and credentialing formats or provide a standardized format for use by all User(s) 10.

In embodiments, the User 10 can interact with Verification Center 20 to designate an immunoprofile detecting laboratory (“I-Lab”) 30, with the Verification Center 20 providing for the I-Lab (e.g., if it is appropriately certified) an I-Lab credential (which can initially be temporary as discussed above) by which the I-Lab can access the account of the User-10 to input immunoprofile data. The credential can be sent directly to the I-Lab (e.g., by mail, secure email, or the like). Or, the credential can be integrated into the I-Lab's standard portal of entry for the I-Lab, such as adding the User's name to a listing of Users for which the I-Lab can provide immune status data. The I-Lab's access can include a requirement for further validation on each access, such as inputting the User's birth date, employer or other data likely to eliminate mistake. In embodiments, the User is provided the credential for delivery to the I-Lab.

In embodiments, the User obtains from the I-Lab a certification of the results, which it inputs into the Verification Center using its credential.

In embodiments, User contracts with the I-lab separately from the Verification Center 20 to establish which antigens User will be tested for immune reaction. In embodiments, User inputs its immune profile needs to the Verification Center, which outputs to User 10 I-Lab options (e.g., cost, location) in the area designated by User 10. In embodiments, upon input by the User 10 of an I-Lab selection, the Verification Center 20 interacts with the I-Lab to provide scheduling options for the User 10 to have the immunoprofile tests initiated (e.g., by collecting bodily fluid such as serum or saliva).

In embodiments, the Verification Center automatically delivers to the I-Lab a work order for the immune response testing. If the Verification Center communicates with the scheduling function of the I-lab, the work order can contain an appointment for drawing needed biological fluid. If not, the appointment is made by the User, or by the I-Lab communicating with the User via contact information provided with the work order.

In establishing or updating an account, User 10 may designate one or more Facilities 40 for which it is seeking permission for access. In embodiments, that designation leads to the Validation Center outputting a credential allowing the Facilities access to a designated portion of the immunoprofile (background information plus, as available, immune response data from the I-Lab) of the User 10. In embodiments, the outputting of the credential can be done if and only if the immunoprofile contains a validation of immunization or immune response against a designated panel of pathogens, such as the panel required by the facility.

If after input from the I-Lab the immunoprofile lacks verification of a necessary immune response, the user 10 can seek immunization from Provider 50. In some embodiments, the Verification Center provides, in response to User's designation of a provider, a credential allowing the Provider to input a certification of immunization. In embodiments, the Verification Center has a portal that allows the Provider 50 to verify its credentials as a medical provider, such that the Providers entry of the immunization data constitutes a certification.

The Verification Center 20 can in embodiments output a query to the User to verify its having read and understood the privacy practices associated with the immunoprofile. The Verification Center 20 can in embodiments output a query to the Facility to verify its having read and understood the privacy practices associated with the immunoprofile. The Verification Center 20 can in embodiments output a query to the Provider to verify its having read and understood the privacy practices associated with the immunoprofile.

In embodiments, the Verification Center can query to User to provide a verification that it understands that it will be releasing a designated portion of the immunoprofile to a given designated Facility, to be used for the purpose of determining if the immunoprofile qualifies the User to enter the Facility. In embodiments, the Verification 20 keeps a database of immunoprofile release requirements of a number of Facilities, and the query seeking User verification is tailored to the requirements of the Facilities that the User designates. For example, where there are two designated Facilities, each with separate requirements, the User verifies its understanding as to each Facility.

The “designated” portion of the immunoprofile can be the entire immunoprofile, or such portion as is necessary to allow access to a given Facility.

An “immunoprofile” is a record of immune status as determined by medical records or by experimental testing. A “lab-tested immunoprofile” is an immunoprofile determined by experimental testing.

The Validation Center 20 typically has controller 50 (FIG. 2) or the equivalent, which can comprise a central processing unit (CPU) 54, a memory 52, and support circuits 56 for the CPU 54 or, alternatively, the controller operates to do so in conjunction with connected computers (or controllers). For example, another electronic device can supply software, or operations may be calculated off-site with controller 50 coordinating off-sight operations with the local environment. The controller 50 may be one of any form of general-purpose computer processor, or an array of processors, that can be used for controlling various devices and sub-processors. The memory, or computer-readable medium, 52 of the CPU 54 may be one or more of readily available memory such as random access memory (RAM), read only memory (ROM), flash memory, floppy disk, hard disk, or any other form of digital storage, local or remote. The support circuits 56 are coupled to the CPU 54 for supporting the processor in a conventional manner. These circuits can include cache, power supplies, clock circuits, input/output circuitry and subsystems, and the like. Methods of operating the analyzer may be stored in the memory 52 as software routine that may be executed or invoked to control the operation of the immunization testing device 100. The software routine may also be stored and/or executed by a second CPU (not shown) that is remotely located from the hardware being controlled by the CPU 54. While the above discussion may speak of the “controller” taking certain actions, it will be recognized that it may take such action in conjunction with connected devices (e.g., the controller physically on the device 100 may have limited capacity, and serve mostly to coordinate communication with more powerful processor(s)).

The invention includes the following numbered embodiments:

Embodiment 1. A method of validating the immunoprofile of a prospective facility user, comprising: (A) providing a portal to a verification center comprising a computer or network of computers, through which portal the user or designee inputs background information into a user immunoprofile, including a designation of one or more facilities, the portal configured to serially query the user for information on immune status as to a series of pathogens; (B) outputting, from the verification center to an immunoprofile laboratory, (i) a work order for determining immune responses for which the user seeks verification to allow the user to visit said facilities, and/or (ii) a credential for the immunoprofile laboratory to input into the user immunoprofile such determined immune responses; and (C) outputting from the verification center a credential for the facility to access a designated portion of the immunoprofile.

Embodiment 2. The method of embodiment 1, wherein the immunoprofile portal includes a query to the user as to which pathogens it needs verification of immune status.

Embodiment 3. The method of one of the foregoing embodiments, wherein the verification center determines, based on the designated facilities, for which pathogens user needs verification of immune status.

Embodiment 4. A method of maintaining an individual(s) (or animals) immunoprofile in a database that validates the individual(s) (or animals) immune status through certified testing and allows this immunoprofile to be accessible by either (i) the individual tested or (ii) by third parties authorized to access the information or (iii) both the individual and the third party.

Embodiment 5. A method of maintaining subject's immunoprofile in a verification center, wherein the immunoprofile validates the subject's immune status through certified testing and validated medical history, the method comprising: (1) providing a portal to the verification center comprising a computer or network of computers, the verification center including a subject's immunoprofile, the immunoprofile including immune status data inputed via the portal by an immunoprofile laboratory; and (2) providing from the verification a credential for one or more of the subject (or its designee) and a facility to access the verification center.

Embodiment 6. The method of embodiment 4 or 5, where the verification center is configured to interact with the subject and/or the immunoprofile laboratory using a standardized credentialing protocol, and is configured to present the immunoprofile in separate formats depending on the facility accessing the immunoprofile.

Embodiment 7. The method one of embodiments 4 to 66, where verification center has a database of the immunoprofile requirements for access to a number of facilities.

Embodiment 8. A method one of embodiments 4 to 7, wherein the verification center is configured to utilize a number of individual credentialing protocols, each matching protocols of individual facilities.

Embodiment 9. A method one of embodiments 4 to 8, where the facilities are hospitals, manufacturing plants, research labs, retail sites, transportation companies, entertainment sites, restaurants, food services, or any site granting access only to individuals with an acceptable immunoprofile.

Embodiment 10. A method one of embodiments 4 to 9, where the subject is a doctor, nurse, medical technical, or other medical professional including representatives of pharmaceutical, biotechnology, and medical device and supply companies.

Embodiment 11. A method one of embodiments 4 to 10, where the user is an animal, veterinarian, pet owner, rancher, farmer, food supplier, or otherwise in the animal related industry.

Embodiment 12. A method of establishing a credentialing system for maintaining the immune status of individuals (or animals) that allows access by authorized users to the immunoprofile information.

Embodiment 13. A method of embodiment 12, where the system allows for a standardized credentialing to establish a protocol and information format that allows users to standardize on how immune status records are maintained, stored, and accessed by those with a need for such information.

Embodiment 14. A method one of embodiments 12 to 13, where the system allows for the credentialing system to be customized so as to allow a user, or multiple users, to utilize their individual protocol and information formats why still using the database to obtain the immunoprofile of those contained in the credentialing system.

Embodiment 15. The method of embodiments 12 to 14, where a standardized credentialing protocol is established to provide a common credentialing protocol to be used by multiple facilities.

Embodiment 16. The method embodiments 12 to 15, where the database is used to determine which individuals (or animals) should be provided access to certain facilities or areas based upon their immunoprofile status.

Embodiment 17. A method of embodiments 12 to 16, where multiple individual credentialing protocols are established so as to accommodate the protocols of individual users.

Embodiment 18. A method of embodiments 12 to 17, where the users are hospitals, manufacturing plants, research labs, retail sites, transportation companies, entertainment sites, restaurants, food services, or any site granting access to their facility to individuals with an acceptable immunoprofile.

Embodiment 19. A method of embodiments 12 to 18, where the user is a doctor, nurse, medical technicial, or other medical professional including representatives of pharmaceutical, biotechnology, and medical device and supply companies.

Embodiment 20. A method of embodiments 12 to 119, where the user is an animal, veterinarian, pet owner, rancher, farmer, food supplier, or otherwise in the animal related industry.

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed:

1. A method of validating the immunoprofile of a prospective facility user, comprising
providing a portal to a verification center comprising a computer or network of computers, through which portal the user or designee inputs background information into a user immunoprofile, including a designation of one or more facilities, the portal configured to serially query the user for information on immune status as to a series of pathogens;
outputting, from the verification center to an immunoprofile laboratory, (i) a work order for determining immune responses for which the user seeks verification to allow the user to visit said facilities, and/or (ii) a credential for the immunoprofile laboratory to input into the user immunoprofile such determined immune responses; and
outputting from the verification center a credential for the facility to access a designated portion of the immunoprofile.

2. The method of claim 1, wherein the immunoprofile portal includes a query to the user as to which pathogens it needs verification of immune status.

3. The method of claim 1, wherein the verification center determines, based on the designated facilities, for which pathogens user needs verification of immune status.

4. A method of maintaining subject's immunoprofile in a verification center, wherein the immunoprofile validates the subject's immune status through certified testing and validated medical history, the method comprising
providing a portal to the verification center comprising a computer or network of computers, the verification center including a subject's immunoprofile, the immunoprofile including immune status data inputed via the portal by an immunoprofile laboratory; and
providing from the verification a credential for one or more of the subject (or its designee) and a facility to access the verification center.

5. The method of claim 4, where the verification center is configured to interact with the subject and/or the immunoprofile laboratory using a standardized credentialing protocol, and is configured to present the immunoprofile in separate formats depending on the facility accessing the immunoprofile.

6. The method in claim 4, where verification center has a database of the immunoprofile requirements for access to a number of facilities.

7. A method of claim 4, wherein the verification center is configured to utilize a number of individual credentialing protocols, each matching protocols of individual facilities.

8. A method of claim 4, where the facilities are hospitals, manufacturing plants, research labs, retail sites, transportation companies, entertainment sites, restaurants, food services, or any site granting access only to individuals with an acceptable immunoprofile.

9. A method of claim 4, where the subject is a doctor, nurse, medical technical, or other medical professional including representatives of pharmaceutical, biotechnology, and medical device and supply companies.

10. A method of claim 4, where the user is an animal, veterinarian, pet owner, rancher, farmer, food supplier, or otherwise in the animal related industry.

11. A method of establishing a credentialing system for maintaining the immune status of individuals (or animals) that allows access by authorized users to the immunoprofile information.

12. A method of claim 11, where the system allows for a standardized credentialing to establish a protocol and information format that allows users to standardize on how immune status records are maintained, stored, and accessed by those with a need for such information.

13. A method of claim 11, where the system allows for the credentialing system to be customized so as to allow a user, or multiple users, to utilize their individual protocol and information formats why still using the database to obtain the immunoprofile of those contained in the credentialing system.

14. The method of claim 11, where a standardized credentialing protocol is established to provide a common credentialing protocol to be used by multiple facilities.

15. The method in claim 11, where the database is used to determine which individuals (or animals) should be provided access to certain facilities or areas based upon their immunoprofile status.

16. A method of claim 11, where multiple individual credentialing protocols are established so as to accommodate the protocols of individual users.

17. A method of claim 11, where the users are hospitals, manufacturing plants, research labs, retail sites, transportation companies, entertainment sites, restaurants, food services, or any site granting access to their facility to individuals with an acceptable immunoprofile.

18. A method of claim 11, where the user is a doctor, nurse, medical technicial, or other medical professional including representatives of pharmaceutical, biotechnology, and medical device and supply companies.

19. A method of claim 11, where the user is an animal, veterinarian, pet owner, rancher, farmer, food supplier, or otherwise in the animal related industry.
